(19) United States
(12) Patent Application Publication
(10) Pub. No.: US 2007/0279334 A1
(43) Pub. Date: Dec. 6, 2007

(54) Crosswire radiation emitter

(76) Inventor: Blaise Laurent Mouttet, Springfield, VA (US)

Correspondence Address: Blaise Mouttet, 4201 Wilson Blvd. #110-364, Arlington, VA, 22203, US

(21) Appl. No.: 11/446,236

(22) Filed: Jun. 5, 2006

(51) Int. Cl. G09G 3/30

(52) U.S. Cl. 345/76

(57) ABSTRACT

A radiation emission element includes a first array of substantially parallel wires and a second array of substantially parallel wires formed at an intersecting angle with the first array of wires. A nanocomposite or molecular film is used as an electroluminescent or electron emissive material and is formed between the first array of wires and the second array of wires. An input unit is connected to the first array of wires and constructed to selectively apply a first voltage to the first array of wires. An output unit connected to the second array of wires and constructed to selectively apply a ground signal to the second array of wires. The spaces between the second array of wires allow for emission of radiation and provide for polarization of the emitted radiation. A visual display may be formed based on the radiation emissive elements.

### CROSS-REFERENCE TO RELATED APPLICATIONS

The following co-pending patent applications, which is incorporated by reference in their entirety, are relevant to the current application:
U.S. application Ser. No. 11/395,237, entitled “Programmable Crossbar Signal Processor,” filed Apr. 3, 2006,
U.S. application Ser. No. 11/395,238, entitled “Parallel Electron Beam Lithography Stamp (PEBLS),” filed Apr. 3, 2006,
U.S. application Ser. No. 11/418,057, entitled “Digital Parallel Electron Beam Lithography Stamp,” filed May 5, 2006, and
U.S. application Ser. No. (not yet assigned), entitled “Crosswire Sensor” filed concurrently with the present application.

### FIELD OF THE INVENTION

The present invention related to radiant energy emitters applicable to a variety of technical fields including lighting, digital displays, and photosensors.

### BACKGROUND OF THE INVENTION

There are a variety of suggestions in the prior art for the use of nanostructured materials and molecular or polymer films in radiant energy generating systems or displays. Using such materials to form light sources or digital display systems offers the potential to form such radiant energy devices with greater energy efficiency and the ability to use flexible films as a substrate material.

Pancove et al. U.S. Pat. No. 5,559,822 provides for the use of quantum dots to form a laser or a multicolor pixel for a digital display. The color of light produced is determined by the size of the quantum dots used.

Favreau U.S. Pat. No. 6,433,702 provides for nanotubes in a touch-sensitive display with luminophore coating of the nanotubes determining the color of the display pixels.

Lee et al. U.S. Pat. No. 6,514,113 provides for nanotubes used to form a white light source.

Kiryuschev et al. U.S. Pat. No. 6,603,259 provides an interwoven array of wires embedded in an electroluminescent material to form a flexible display.

In order to increase efficiency in radiant energy systems such as those of the prior art a more effective addressing system needs to be developed.

### SUMMARY OF INVENTION

The present invention pertains to a radiant energy emitting element employing a crosswire addressing system. A first array of substantially parallel wires and a second array of substantially parallel wires formed at an intersecting angle with the first array of wires are provided. Radiant energy emitting material is formed between the first array of wires and the second array of wires. An input unit is connected to the first array of wires and constructed to selectively apply a first voltage to the first array of wires and an output unit is connected to the second array of wires and constructed to selectively apply a second voltage or a ground signal to the second array of wires to emit radiation based upon both the selective application of the first voltage to the first array of wires and the selective application of the second voltage or ground signal to the second array of wires.

The radiant energy emitting element may be used as a light source or electron source, depending on the type of radiant energy emitting material used. The radiant energy emitting material may be combined with a photodetector and used as a photosensor or photointerrupter. An array of columns and rows of such radiant energy emitting elements may be used to form a digital display device.

The present invention provides an addressing and control mechanism for radiation emissive elements providing many possible advantages over prior art designs including a simple structure, low feedback current, adaptability to flexible substrates, and intrinsic polarization of emitted radiation.

### BRIEF DESCRIPTION OF THE DRAWINGS

FIG. 1 illustrates a top view of a crosswire radiant energy emitter array according to a basic embodiment of the present invention.

FIGS. 2a and 2b illustrate two cross-sections of a particular radiant energy emitter element prior to fabrication.

FIGS. 2c and 2d illustrate two cross-sections of a particular radiant energy emitter element after fabrication.

FIG. 3 illustrates radiant energy generated by one of two adjacent sensor elements.

FIG. 4a illustrates an embodiment of an input unit for the crosswire radiant energy emitter array.

FIG. 4b illustrates an embodiment of an output unit for the crosswire radiant energy emitter array.

FIG. 5a-5b illustrates addressing of the crosswire radiant energy emitter array.

FIG. 6 illustrates a control configuration for a light source of photosensor.

### DETAILED DESCRIPTION OF THE INVENTION

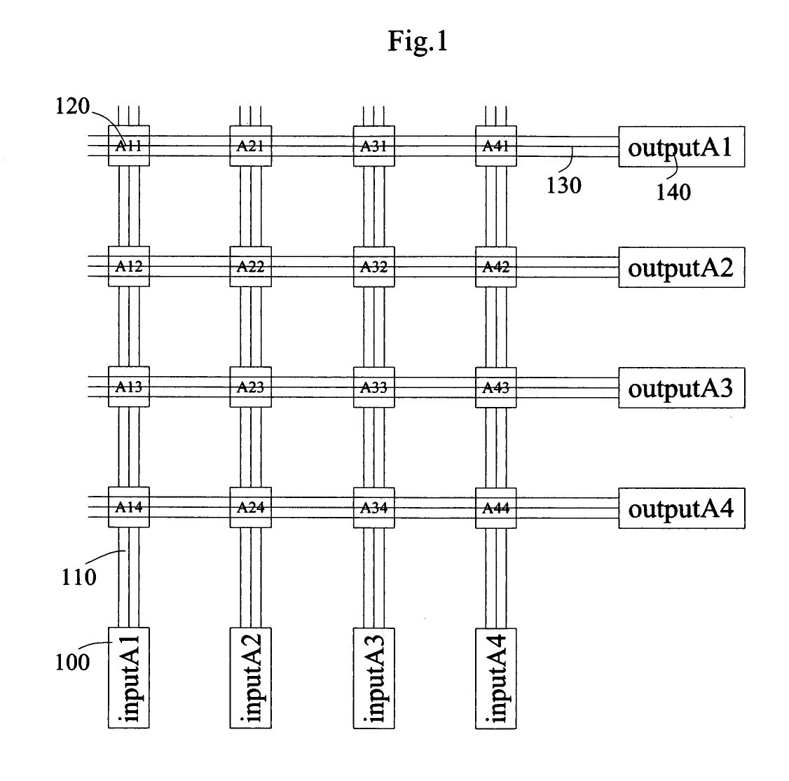

FIG. 1 illustrates a basic embodiment of the present invention. Input units 100 (inputA1, inputA2, inputA3, inputA4) each selectively provide a first positive voltage to a first array of parallel metallic or p-doped wires 110. A radiant energy emission material 120 is coated or formed above the wires 110 and a second array of parallel metallic or n-doped wires 130 are formed above material 120. Wires 130 are connected to output units 140 (outputA1, outputA2, outputA3, outputA4) which each selectively provide a negative or ground voltage to the wires 130. Sixteen radiant energy emitting elements A11-A44 are shown in a 4×4 array.

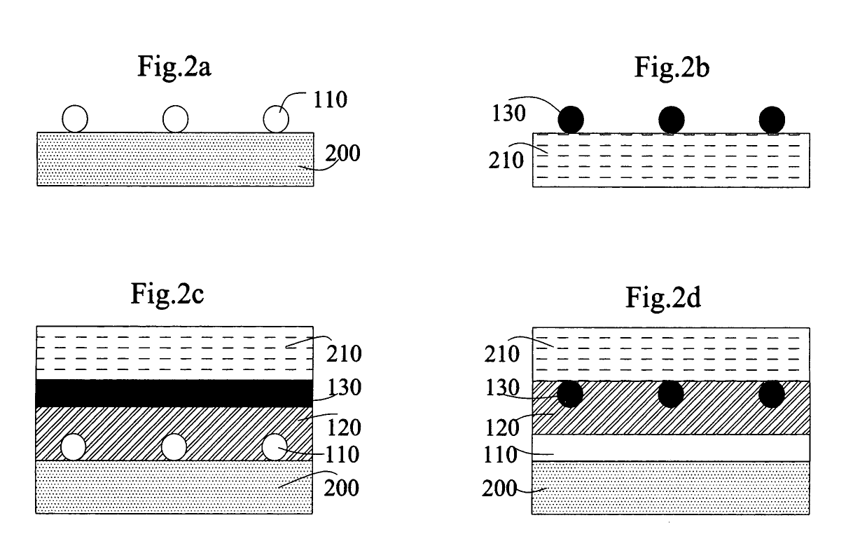

FIGS. 2a and 2b illustrate two cross-sections of a particular radiation emitting element prior to fabrication. In FIG. 2a, a substrate 200 is provided, which may be opaque, reflective, or transparent, depending upon the desired application. Wiring 110 may be patterned on the substrate using a chemical or physical deposition technique as commonly used in the semiconductor processing industry. For nanoscale resolution wiring, other techniques may be employed including nanoimprint lithography, copolymer self-assembly, or a PEBLS technique as disclosed in copending U.S. patent applications Ser. Nos. 11/395,238 and 11/418,057. In addition, silkscreen printing or inkjet printing may be utilized to pattern the wiring if the substrate 200 is desired to be a flexible film. The wiring 110 should be formed of a p-doped conductive material or, equivalently, as a metallic material with a p-type surface layer. In FIG. 2b, a transparent substrate 210 is provided with wiring 130 which is patterned in the same or a similar manner as wiring 110 except the wiring is made from an n-doped material or a metallic material with an n-type surface layer. The p-doping and n-doping of the separate wiring arrays allows for avoidance of unwanted feedback so that current flow occurs primarily only in the direction from wiring 110 to wiring 130. Kuekes et al. U.S. Pat. No. 6,128,214 discussed the utility of such p-type/n-type wiring arrays separated by molecular films in memory devices. Radiant energy emissive material 120 may be formed using nanocomposites including nanotubes or quantum dots or by using electroluminescent polymer or molecular films. FIG. 2c illustrates a cross-section of the sensor element parallel to wiring 130 and FIG. 2d illustrates a cross-section of the sensor element parallel to wiring 110.

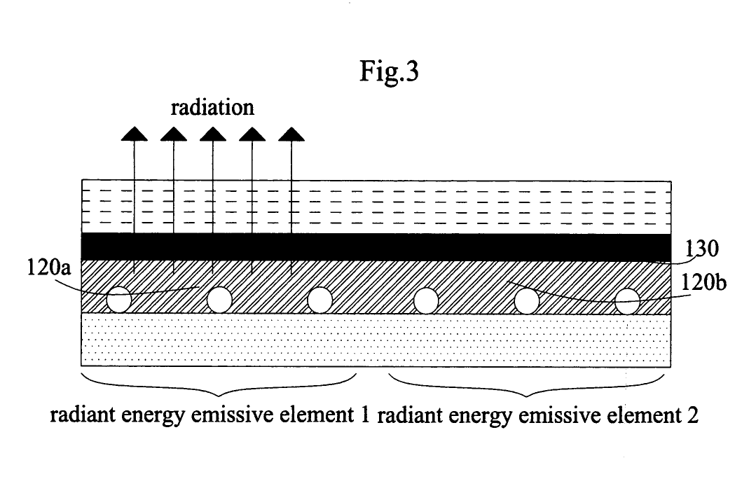

FIG. 3 illustrates two adjacent emission elements wherein only element 1 is energized. The emitted radiation, in the form of electromagnetic energy (photons) or electrons, pass through the spaces between wiring 130. For the case of electromagnetic wave radiation, providing a small interspacing between the wiring 130 may constructively be applied to create a polarization effect on the emitted radiation, transmitting only the EM waves parallel to the wiring 130 through the gaps of the wiring.

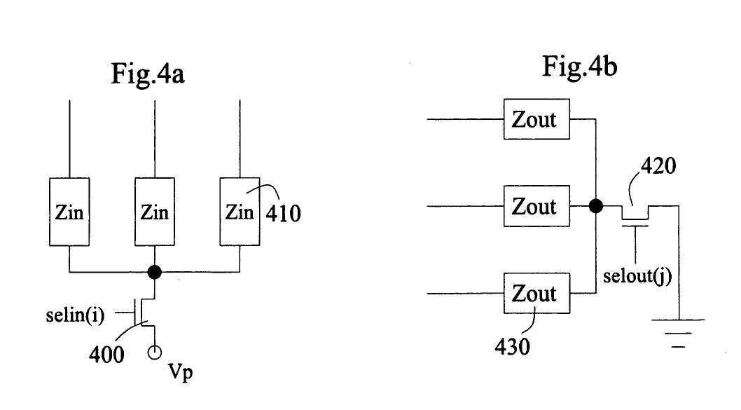

FIG. 4a illustrates an embodiment of an input unit 100 while FIG. 4b illustrates an embodiment of output unit 140. In the input unit, a positive voltage Vₚ is selectively applied via actuation of transistor 400 (conceivably other switching mechanisms such as MEMS switches may be utilized for this function). Zᵢₙ 410 is representative of the impedances resulting from resistive/capacitive/inductive effects in the input wiring 110. In the output unit, selective actuation of transistor 420 (again other switching mechanisms may be used) forms a ground connection. Zₒᵤₜ 430 is representative of the impedances resulting from resistive/capacitive/inductive effects in the input wiring 110. A particular radiant energy element may be addressed via a control unit such as a general purpose microprocessor under software control, or alternatively by an application specific integrated circuit, by providing an actuation signal selin(i) (1≦i≦N) to select a particular column and providing an actuation signal selin (j) (1≦j≦M) to select a particular row. N and M refer to the number of respective columns and rows in the matrix of radiant energy elements. Depending on the desired application, N and M may take values from 1 to several thousand. It is noted that the values of Zᵢₙ may be manufactured to be different for different columns, while Zₒᵤₜ may be manufactured to be different for different rows, in order to balance parasitic differences in column/rows due to different total wiring lengths (see co-pending U.S. patent application Ser. No. 11/395,237 for further details on parasitic balancing).

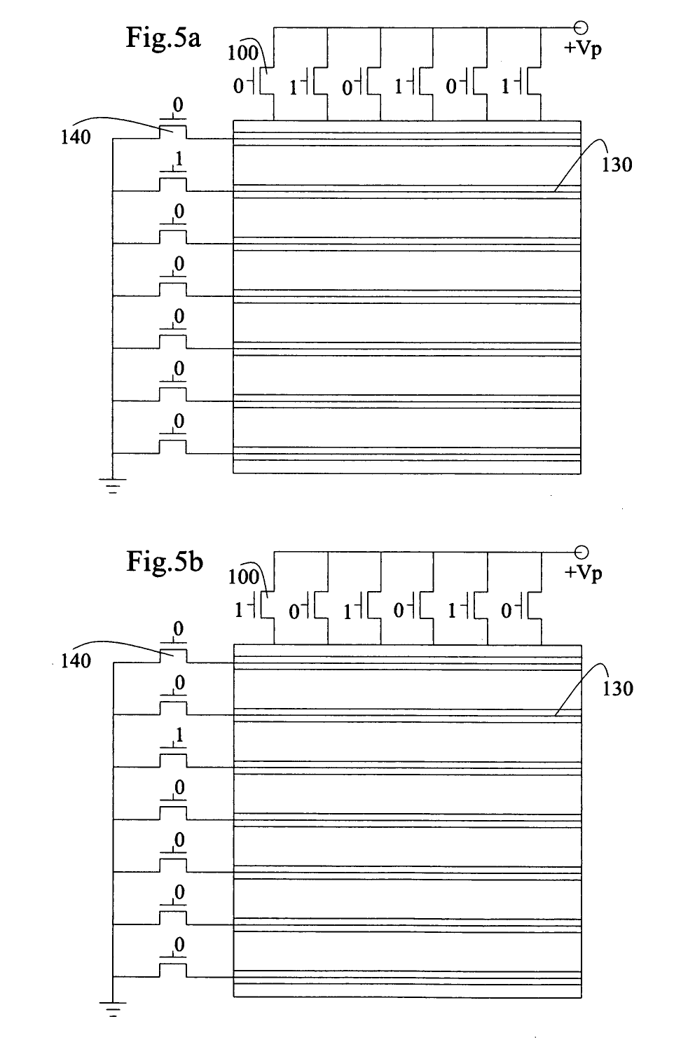

Progressive selection of all of the radiant energy elements in a two dimensional array provides for creation of a digital image pattern of pixels for a digital display. FIG. 5a illustrates addressing the second, fourth, and sixth elements of the second row by selective actuation of the input and output units. FIG. 5b illustrates addressing the first, third, and fifth elements of the third row by selective actuation of the input and output units. Using known addressing circuitry, such as shift register, latching, and timing circuits, two dimensional digital raster data may be converted to a visual image for presentation of static or dynamic information. By using different types of the radiant energy emissive material such as different size quantum dots, different fluorescent material, etc. different colors (i.e. blue, green, red) may be produced as known to the art. It would of course be obvious to combine any useful teaching in the art of digital display devices to the current invention.

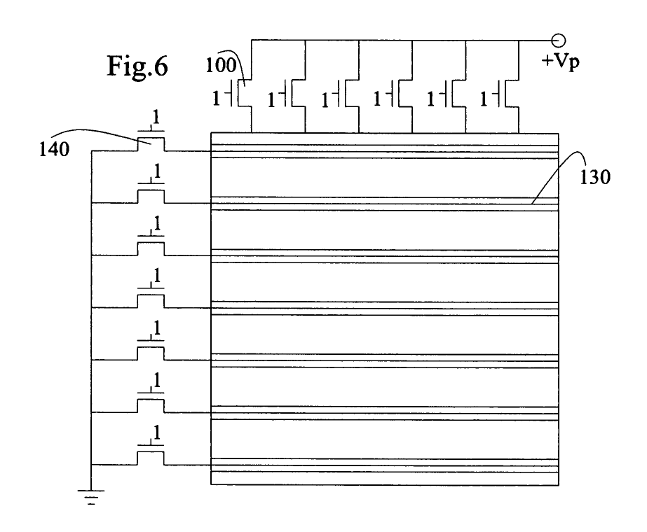

In an alternative application, providing a common signal to all of the input/output elements as in FIG. 6 provides for a uniform radiant energy source useful for lighting or as a component of a photosensor or photointerrupter. When used in a photointerrupter or photosensor, the sensing element may be a conventional light sensor or a crosswire sensor as disclosed in the co-pending application entitled “Crosswire Sensor”. Since a common wiring structure exists for the crosswire sensor and the crosswire radiation emitter integration on a common substrate would be facilitated.

### Modifications/Alternatives

It is noted that in the above description provides illustrative but non-limiting examples of the present invention. In the examples, the number of wires in the first wiring 110 and second wiring 130 of a radiant energy emitting element was set to be three. However, depending on the diameter of the wires and the interspacing between wires, the number of intersecting wires may be anywhere from 2×2 to over 100×100 per emitting element. Clearly using a larger number of wires of a given diameter will have the advantage of fault tolerance of broken or corrupt wire paths while using a smaller number of wires of a given diameter will have the advantage of higher resolution. The particular diameter of the wires used may range from below 10 nm to above 10 microns depending on the intended use and fabrication procedure employed. While above embodiments have associated first wiring 110 with substrate 200 and second wiring 130 with transparent substrate 210 this association may be reversed.

While an 8×8 emission element array has been illustrated as an example, arrays of smaller (2×2, 3×3, etc) or larger size (100×100, 1000×1000, etc.) may be used. In addition differing numbers of rows than columns may obviously be employed such as 2×8, 8×2, 50×200, etc.

The input and output circuits may be formed on the same substrate (to reduce parasitic wiring loss) or a different substrate (to ease fabrication of different components) from the array of wires and radiant energy emitting material. In addition, when formed on different substrates, wireless techniques may be advantageously used to communicate from a control circuit containing the input and output circuits and the substrate with the radiant energy sensitive material. RF transponders are one available technology to enable such communication.

Many possible applications are seen to exist for the technology of the present invention and while particular discussion of digital display, lighting, and photosensor embodiments have been taught above the present invention is not limited to such applications.

The present invention is only limited by the following claims.

I claim:

1. A radiation emissive element comprising:
a first array of substantially parallel wires;
a second array of substantially parallel wires formed at an intersecting angle with the first array of wires;
radiant energy emitting material between the first array of wires and the second array of wires;
an input unit connected to the first array of wires and constructed to selectively apply a first voltage to the first array of wires; and
an output unit connected to the second array of wires and constructed to selectively apply a second voltage, less than the first voltage, or a ground voltage to the second array of wires,
wherein the radiant energy emitting material emits radiation based upon both the selective application of the first voltage to the first array of wires and the selective application of the second voltage to the second array of wires.

2. The radiation emissive element of claim 1, wherein the radiant energy emitting material is electrolumenescent material used for photon emission.

3. The radiation emissive element of claim 1, wherein the radiant energy emitting material is a molecular or polymer film.

4. The radiation emissive element of claim 1, wherein the radiant energy emitting material includes quantum dots.

5. The radiation emissive element of claim 1, wherein the radiant energy emitting material includes nanotubes used for electron emission.

6. The radiation emissive element of claim 1, wherein the wires of the first array of wires and the second array of wires have a diameter of less than 100 nm.

7. The radiation emissive element of claim 1, wherein the wires of the first array of wires and the second array of wires have a diameter equal to or greater than 100 nm.

8. The radiation emissive element of claim 1, wherein the first array of wires are p-doped and the second array of wires are n-doped.

9. The radiation emissive element of claim 1, wherein the first array of wires is formed adjacent a reflective surface.

10. The radiation emissive element of claim 1, wherein the first array of wires is formed adjacent a transparent surface.

11. The radiation emissive element of claim 1, wherein the second array of wires is formed adjacent a transparent surface.

12. The radiation emissive element of claim 1, wherein the second array of wires polarizes the emitted radiation.

13. The radiation emissive element of claim 1, wherein the first voltage is a positive voltage and the second voltage is a ground voltage.

14. A display comprising:
a plurality of radiation emissive elements arranged in columns and rows and an addressing unit for addressing particular radiation emissive elements, wherein each of the radiation emissive elements includes:
a first array of substantially parallel wires;
a second array of substantially parallel wires formed at an intersecting angle with the first array of wires; and
radiant energy emitting material between the first array of wires and the second array of wires;
and wherein the addressing unit includes:
a plurality of input units, each input unit connected to a particular column of the radiation emissive elements and constructed to selectively apply a first voltage to multiple wires of the particular column; and
a plurality of output units, each output unit connected to a particular row of the radiation emissive elements and constructed to selectively apply a second voltage, less than the first voltage, or a ground signal to multiple wires of the particular row,
wherein sequential addressing of radiation emissive elements results in the generation of a visual image.

15. The display of claim 14, wherein the radiant energy emitting material is electrolumenescent material used for photon emission.

16. The display of claim 14, wherein the radiant energy emitting material is a molecular or polymer film.

17. The display of claim 15, wherein the radiant energy emitting material includes quantum dots.

18. The display of claim 15, wherein the radiant energy emitting material includes nanotubes used for electron emission.

19. The display of claim 15, wherein the first arrays of wires are p-doped and the second arrays of wires are n-doped.

20. The display of claim 15, wherein the second arrays of wires polarizes the emitted radiation.
